(19) United States
(12) Patent Application Publication
(10) Pub. No.: US 2019/0065984 A1
(43) Pub. Date: Feb. 28, 2019

(54) METHOD AND ELECTRONIC DEVICE FOR DETECTING AND RECOGNIZING AUTONOMOUS GESTURES IN A MONITORED LOCATION

(71) Applicant: MOTOROLA MOBILITY LLC, Chicago, IL (US)

(72) Inventors: VIVEK K. TYAGI, CHICAGO, IL (US); JOSEPH V. NASTI, CHICAGO, IL (US); SUDHIR VISSA, BENSENVILLE, IL (US)

(21) Appl. No.: 15/684,535

(22) Filed: Aug. 23, 2017

(51) Int. Cl. G06N 99/00; H04W 4/02; G06F 17/30

(52) U.S. Cl. CPC G06N 99/005; G06F 3/0346; G06F 17/30241; H04W 4/021

(57) ABSTRACT

A method and electronic device for detecting and recognizing autonomous gestures in a monitored location. The method includes receiving, at a processor, data collected by a user device. The data includes at least one coordinate that is indicative of a geographic location of the user device and corresponds to at least one specific movement of the user device. The method includes determining, by a processor, whether the geographic location of the user device is an identified, monitored location, in which user activities are monitored. In response to the geographic location being an identified, monitored location, the method includes determining which specific movements are presented by the coordinate. From a database, the method includes identifying a performance of a specific operation that correlates to the coordinate. The method further includes performing a second operation, based, in part, on an identified specific operation that is being performed in the geographic location.

### BACKGROUND

### 1. Technical Field

The present disclosure generally relates to monitoring devices and in particular to a method and electronic device for detecting and recognizing autonomous gestures that occur in monitored locations.

### 2. Description of the Related Art

Commercial areas, such as warehouses, airports, factories, laboratories, and stores require the frequent movement of packages, resources, and products (generally “moveable objects”). In a typical warehouse scenario, for example, where workers stock, rack, and mount packages constantly, many manual steps are required to keep track of the workers' activity with respect to the movement/relocation/restocking of moveable objects. These steps can often include having the worker manually scan packages for inventory keeping and/or other tracking purposes. Having a worker manually scan packages decreases productivity and increases the chance of human error.

In certain scenarios, it may also be desirable to track movements being made by a person within specific locations. Where those movements include the frequent movement of moveable objects, the movement of these objects in these areas can result in personal injury, loss or misplacement of inventory for various reasons, misuse of company resources, etc. Currently, there is no mechanism or methodology for keeping track of these movements as they occur within the location.

### BRIEF DESCRIPTION OF THE DRAWINGS

The description of the illustrative embodiments is to be read in conjunction with the accompanying drawings. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 provides a block diagram representation of an example data processing system within which certain aspects of the disclosure can be practiced, in accordance with one or more embodiments;

FIG. 2 illustrates a mobile device within which certain aspects of the disclosure can be practiced, in accordance with one or more embodiments;

FIG. 3A illustrates a sensing network having a plurality of different types of sensors associated with different objects that transmit location signals to a receiving device for tracking movement within the location, in accordance with one or more embodiments;

FIG. 3B illustrates an example of geolocation sensors and/or transmitters located within a monitored location within which certain aspects of the disclosure can be practiced, according to one or more embodiments;

FIG. 4 illustrates an example of a sequence of translational activities taking place in a monitored location, in accordance with one or more embodiments;

FIG. 5 illustrates an example sensing device for detecting the transmission of electrical signals from sensor-equipped devices at a geographic location, according to one or more embodiments;

FIG. 6 is a flow chart illustrating a method for determining when to perform a second operation, based, in part, on an identified specific operation that is being performed in a monitored location, in accordance with one or more embodiments; and

FIG. 7 is a flow chart illustrating a method for correlating specific movements being performed in a monitored location with a resulting operation that can affect an object and/or a person associated with the movement, in accordance with one or more embodiments.

### DETAILED DESCRIPTION

Disclosed are a method, an electronic device, and a computer program product for identifying activities and/or events occurring at a monitored geographic location based on a sequence of movements associated with a user device. According to one embodiment, a processor of a data processing system receives data collected by at least one user device. The data includes at least one coordinate that is, at least in part, indicative of a geographic location of the user device, and the data presents information that corresponds to at least one specific movement of the user device within the geographic location. In response to receiving the data, a processor determines whether the geographic location of the user device is a monitored location in which activities are monitored. In response to the geographic location being a monitored location, the processor determines which specific movements are presented by the at least one coordinate. The processor identifies, from a database, a performance of a specific operation that correlates to the specific movements at the at least one coordinate. Further, the processor performs a second operation, based, in part, on an identified specific operation that is being performed in the geographic location.

The method includes receiving, at a processor of a data processing system, data collected by at least one user device. The data includes at least one location coordinate that is, at least in part, indicative of a geographic location of the user device and which corresponds to at least one specific movement of the user device, within the geographic location. In response to receiving the data, the method includes determining, by the processor, whether the geographic location of the user device is a monitored location in which user activities are tracked/monitored. In response to the geographic location being a monitored location, the method further includes determining which specific movements are presented by the at least one location coordinate. The method includes identifying, from a database, a performance of a specific operation that correlates to the movements at the at least one location coordinate. The method further includes performing a second operation, based, in part, on an identified specific operation that is being performed in the geographic location.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “alternate embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

Those of ordinary skill in the art will appreciate that the hardware components and basic configuration depicted in the following figures may vary. For example, the illustrative components within the presented devices are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

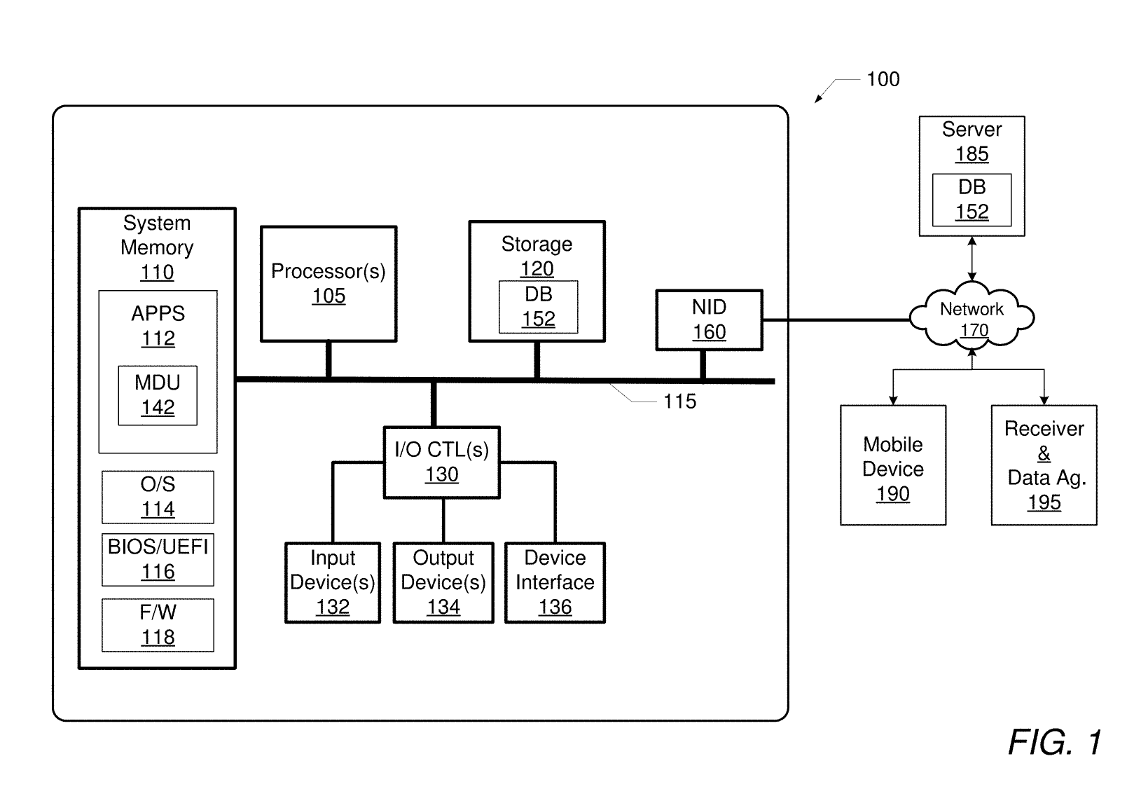

FIG. 1 illustrates a block diagram representation of a data processing device, for example data processing system (DPS) 100, within which one or more of the described features of the various embodiments of the disclosure can be implemented. For example, a data processing system may be a handheld device, personal computer, a server, a network storage device, or any other suitable device and may vary in size, shape, performance, functionality, and price.

Referring specifically to FIG. 1, example DPS 100 includes one or more processor(s) 105 coupled to system memory 110 via system interconnect 115. System interconnect 115 can be interchangeably referred to as a system bus, in one or more embodiments. Also coupled to system interconnect 115 is storage 120 within which can be stored one or more software and/or firmware modules and/or data (not specifically shown). Stored within storage 120 is database 152. Database 152 can be a location-based operation mapping (LBOM) database. In an alternate embodiment, database 152 is also stored, or alternatively stored within server 185.

In one embodiment, storage 120 can be a hard drive or a solid-state drive. The one or more software and/or firmware modules within storage 120 can be loaded into system memory 110 during operation of DPS 100. As shown, system memory 110 can include therein a plurality of software and/or firmware modules including application(s) 112, operating system (O/S) 114, basic input/output system/unified extensible firmware interface (BIOS/UEFI) 116 and other firmware (F/W) 118. The various software and/or firmware modules have varying functionality when their corresponding program code is executed by processor(s) 105 or other processing devices within DPS 100.

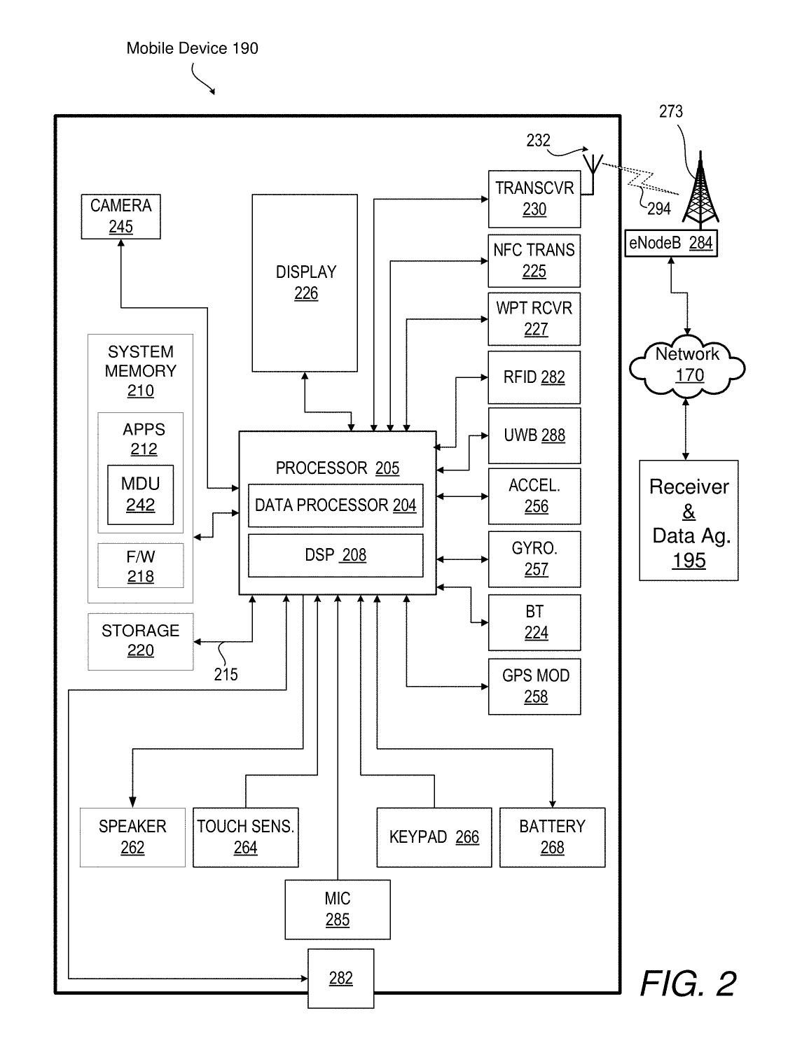

For example, DPS 100 includes movement detection utility (MDU) 142. MDU 142 may be provided as an application that is optionally located within system memory 110 and executed by processor 105. Within this embodiment, processor 105 executes MDU 142 to provide the various methods and functions described herein. For simplicity, MDU 142 is illustrated and described as a stand-alone or separate software/firmware/logic component, which provides the specific functions and methods described herein. However, in at least one embodiment, MDU 142 may be a component of, may be combined with, or may be incorporated within OS 114, and/or with one or more applications 112. Additional aspects of MDU 142, and functionality thereof, are presented within the description of FIGS. 2-7.

DPS 100 further includes one or more input/output (I/O) controllers 130, which support connection by, and processing of signals from, one or more connected input device(s) 132, such as a keyboard, mouse, touch screen, or microphone. I/O controllers 130 also support connection to and forwarding of output signals to one or more connected output devices 134, such as a display, audio speaker(s). Additionally, in one or more embodiments, one or more device interfaces 136, such as an optical reader, a universal serial bus (USB), a card reader, Personal Computer Memory Card International Association (PCMIA) slot, and/or a high-definition multimedia interface (HDMI), can be coupled to I/O controllers 130 or otherwise associated with DPS 100. Device interface(s) 136 can be utilized to enable data to be read from or stored to additional devices (not shown) for example a compact disk (CD), digital video disk (DVD), flash drive, or flash memory card. In one or more embodiments, device interfaces 136 can further include General Purpose I/O interfaces, such as an Inter-Integrated Circuit (I²C) Bus, System Management Bus (SMBus), and peripheral component interconnect (PCI) buses. Further, in one or more embodiments device interface 136 receives input from mobile device 190, as well as receiver and data aggregator 195. Receiver and data aggregator 195 is a circuit that detects communications transmitted from sensors. The sensors may be, for example, a radio frequency identification (RFID) sensor, a real-time location system (RTLS) sensor, and ultra-wideband (UWB) transceiver. Additional aspects of receiver and data aggregator 195, and functionality thereof, are presented within the description of FIGS. 2-7.

DPS 100 further comprises a network interface device (NID) 160. NID 160 enables DPS 100 to communicate and/or interface with other devices, services, and components that are located external (remote) to DPS 100, for example, server 185, mobile device 190, receiver and data aggregator 195, and other user devices, via a communication network. These devices, services, and components can interface with DPS 100 via an external network, such as example network 170, using one or more communication protocols. Network 170 can be a local area network, wide area network, personal area network, signal communication network, and the like, and the connection to and/or between network 170 and DPS 100 can be wired or wireless or a combination thereof. For purposes of discussion, network 170 is indicated as a single collective component for simplicity. However, it is appreciated that network 170 can comprise one or more direct connections to other devices as well as a more complex set of interconnections as can exist within a wide area network, such as the Internet.

In the description of the following figures, reference is also occasionally made to specific components illustrated within the preceding figures, utilizing the same reference numbers from the earlier figures. With reference now to FIG. 2, there is illustrated example mobile device 190. Mobile device 190 includes at least one processor integrated circuit, processor 205. Included within processor 205 are data processor 204 and digital signal processor (DSP) 208. Processor 205 is coupled to system memory 210 and non-volatile storage 220 via a system communication mechanism, such as system interconnect 215. System interconnect 215 can be interchangeably referred to as a system bus, in one or more embodiments. One or more software and/or firmware modules can be loaded into system memory 210 during operation of mobile device 190. Specifically, in one embodiment, system memory 210 can include therein a plurality of such modules, including firmware (F/W) 218. System memory 210 may also include basic input/output system and an operating system (not shown). The software and/or firmware modules provide varying functionality when their corresponding program code is executed by processor 205 or by secondary processing devices within mobile device 190.

Processor 205 supports connection by and processing of signals from one or more connected input devices such as camera 245, speaker 262, touch sensor 264, microphone 285, keypad 266, and display 226. Additionally, in one or more embodiments, one or more device interfaces 282, such as an optical reader, a universal serial bus (USB), a card reader, Personal Computer Memory Card International Association (PCMIA) slot, and/or a high-definition multimedia interface (HDMI), can be associated with mobile device 190. Mobile device 190 also contains a power source such as a battery 268 that supplies power to mobile device 190.

Mobile device 190 further includes Bluetooth transceiver 224, global positioning system module (GPS MOD) 258, gyroscope 257, accelerometer 256, ultra-wideband (UWB) transceiver 288, and radio frequency identification (RFID) sensor 282 all of which are communicatively coupled to processor 205. Bluetooth transceiver 224 enables mobile device 190 and/or components within mobile device 190 to communicate and/or interface with other devices, services, and components that are located external to mobile device 190. GPS MOD 258 enables mobile device 190 to communicate and/or interface with other devices, services, and components to send and/or receive geographic position information. Gyroscope 257 communicates the angular position of mobile device 190 using gravity to help determine orientation. Accelerometer 256 is utilized to measure non-gravitational acceleration and enables processor 205 to determine velocity and other measurements associated with the quantified physical movement of a user. RFID sensor 282 utilizes electromagnetic fields to automatically identify and track RFID tags attached to objects. UWB transceiver 288 uses radio technology that can operate with very low energy levels to send and/or receive high-bandwidth communications within an approximated range.

Mobile device 190 is presented as a wireless communication device. As a wireless device, mobile device 190 can transmit data over wireless network 170. Mobile device 190 includes transceiver 230, which is communicatively coupled to processor 205 and to antenna 232. Transceiver 230 allows for wide-area or local wireless communication, via wireless signal 294, between mobile device 190 and evolved node B (eNodeB) 284, which includes antenna 273. Mobile device 190 is capable of wide-area or local wireless communication with other mobile wireless devices or with eNodeB 284 as a part of a wireless communication network. Mobile device 190 communicates with other mobile wireless devices by utilizing a communication path involving transceiver 230, antenna 232, wireless signal 294, antenna 273, and eNodeB 284. Mobile device 190 additionally includes near field communication transceiver (NFC TRANS) 225 wireless power transfer receiver (WPT RCVR) 227. In one embodiment, other devices within mobile device 190 utilize antenna 232 to send and/or receive signals in the form of radio waves. For example, GPS module 258 can be communicatively couple to antenna 232 to send/and receive location data.

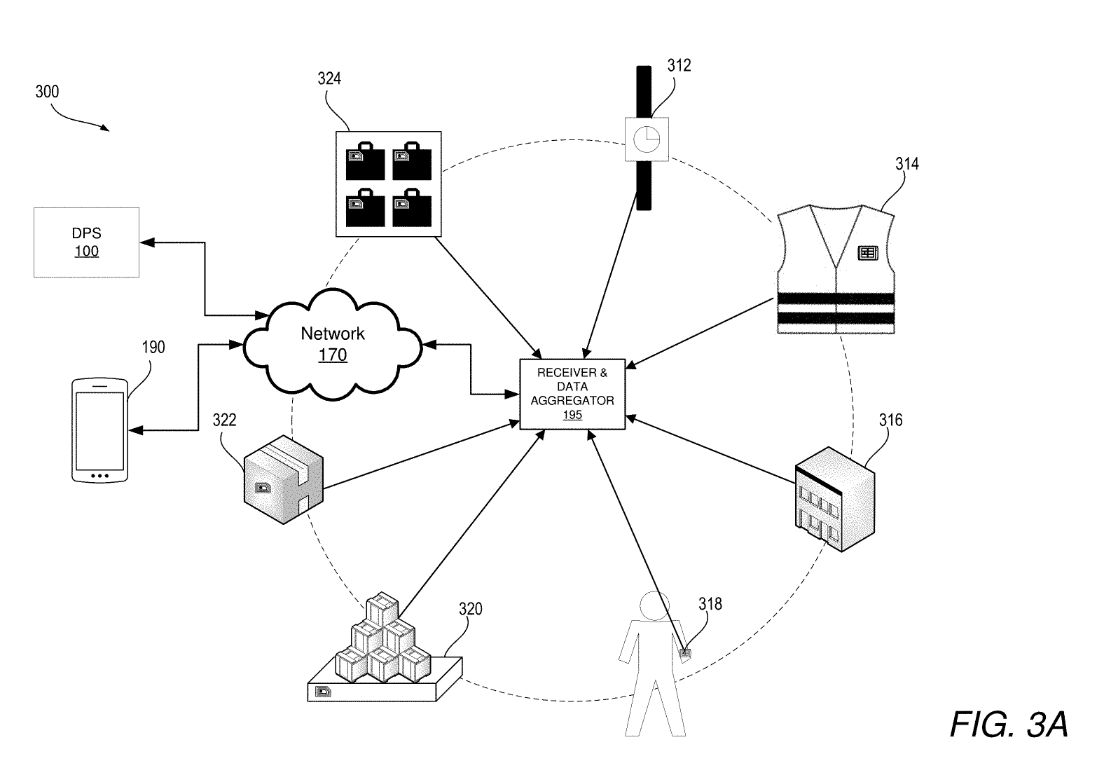

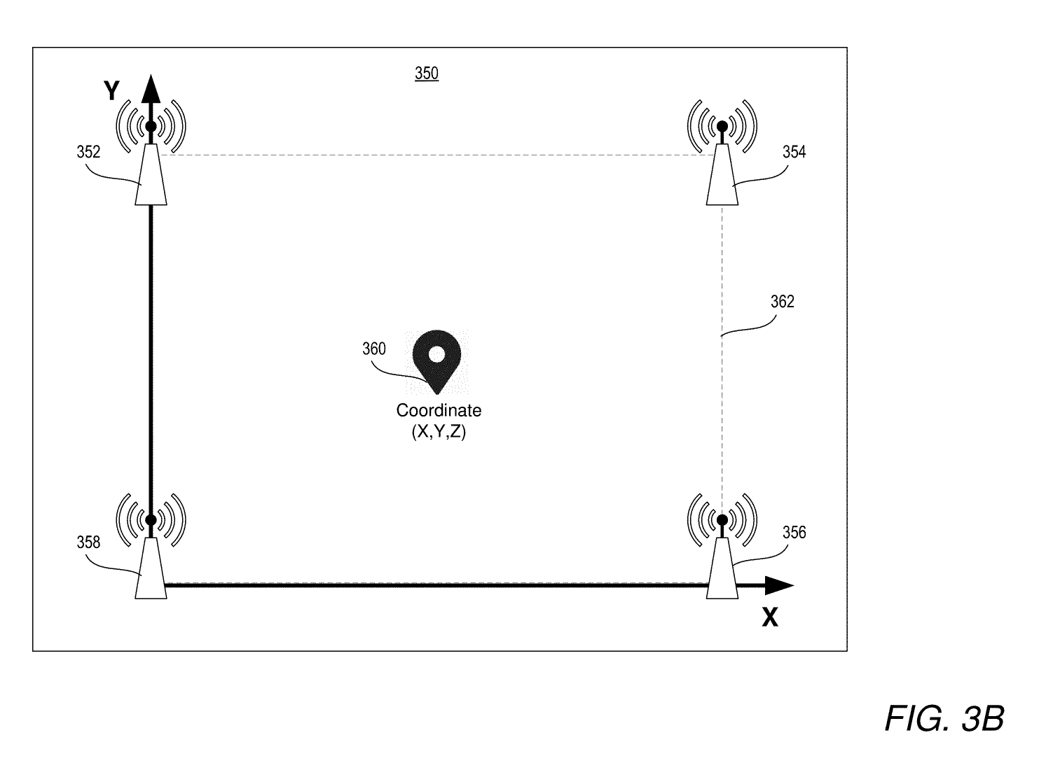

As provided by FIG. 2, mobile device 190 additionally includes MDU 242 which executes on processor 205 to enable the processing of data received from receiver and data aggregator 195. In at least one embodiment, MDU 242 may be a component of, may be combined with, or may be incorporated within one or more applications 212. Mobile device 190 and components thereof are further discussed in FIG. 3A.

With reference now to FIG. 3A, illustrates sensing network 300 having a plurality of different types of sensors associated with different objects that transmit location signals to a receiving device for tracking movement within the location. Example group of devices and objects within sensor network 300 include at least one DPS, DPS 100, at least one mobile device 190, and receiver and aggregator 195. Each sensor equipped object provides a communication signal utilized to enable certain aspects of the disclosure. Additionally, included within sensor network 300 are watch 312, clothing 314, enclosed structure 316, wearable sensor 318, object transport structure 320, object 322, and luggage 324. Sensor network 300 comprises at least one wireless communication-enabled device that has at least one sensing capability. Thus, at least one sensing capability is provided by watch device 312, clothing 314, enclosed structure 316, wearable sensor 318, object transport structure 320, object 222, and/or luggage 324. Wearable sensor 318 can be, for example, a sensor injected under the epidermis of a user. Specifically, the sensing devices/capabilities provided by the example group of devices and objects in sensor network 300 may include the following sensing technologies: a gyroscope, an accelerometer, global positioning sensor (GPS), Bluetooth, infrared data association (IrDA), RFID, real-time location system (RTLS), UWB, wireless local area network (WLAN), and Zigbee. These various technologies enable the sensing device to communicate specific location and movement data that represent one or more location coordinates presented to DPS 100.

Receiver and data aggregator 195 is a circuit that detects communications transmitted from sensors from the example group of devices and objects. Receiver and data aggregator 195 is communicatively connected to wireless network 170, enabling receiver and data aggregator 195 to communicate each occurrence of movement to DPS 100 and/or mobile device 190. Further, receiver and data aggregator 195 receives each communication signal as they are transmitted in real-time and aggregates the signals to a form that can be transmitted to and processed by DPS 100 and/or mobile device 190. Each communication signal provides, at least in part, a location coordinate. In one embodiment, receiver and aggregator 195 is located within mobile device 190. Data received by receiver and data aggregator 195 is not limited to location coordinates, but, for example, can be general spatial coordinates within the location, weight of an object, contents of a package, detected heartbeat of the user utilizing a sensing device, etc.

RFID sensor 282 can be associated with an RFID system that generates an RFID tag, modifies information on an RFID tag, or receives information from an RFID tag. RFID systems include tags and/or labels attached to objects that can be identified by a two-way RFID transmitter-receiver. The two-way RFID transmitter-receiver, also called a reader, sends a signal to the tag and reads the response. The RFID tag may be attached to and/or imbedded in an object such as object 322, and contains electronically stored information. Radio waves are utilized to transmit the electronically stored information. The signal output from a RFID tag can be received by DPS 100, network 170, mobile device 190, receiver and data aggregator 195, and/or another device in sensor network 300. In one embodiment, the signal output from a RFID tag triggers the operation of another device within sensor network 300. Likewise, a device having an RFID sensor, for example RFID sensor 282 can receive an instructive signal from DPS 100 (as enabled by MDU 142) for performing a second operation, for example, reading an RFID tag. Additionally, in one embodiment detection of a signal output from a first RFID tag can initiate the generation of a second RFID tag. The second RFID tag can be created on location (or elsewhere) by selecting a unique RFID label that corresponds to the object that is being tagged. A device such as mobile device 190 generates the tag and enables printing of the tag on location (or elsewhere) using a suitable printing material.

Watch 312, clothing 314, enclosed structure 316, wearable sensor 318, object transport structure 320, object 322, and luggage 324 can include, for example, a real-time location system (RTLS) sensor. The RTLS sensor is another type of sensor utilized to transmit signals to DPS 100, mobile device 190, and/or receiver and data aggregator 195 via network 170. The RTLS sensor utilizes technologies such as Wi-Fi, Bluetooth, UWB, RFID, and global positioning system (GPS) to emit signals. The signals emitted by a device having the RTLS technology provides a current geolocation of a target and/or an object. Various GPS technologies can be integrated to form a highly sensitive indoor GPS. For example, for enclosed structure 316, technologies such as assisted GPS with massive parallel correlation and laser indoor GPS are combined to form the highly sensitive GPS.

Mobile device 190 is a telecommunication device that uses radio waves in a networked area to enable wireless communicative transmission over a large distance. For example, mobile device 190 and watch device 312 are presented as wireless communication devices. As a wireless communication device, mobile device 190 and watch device 312 can transmit data over eNobeB 284. Mobile device 190 and watch device 312 can additionally include near field communication transceiver (NFC TRANS) and a wireless power transfer receiver (WPT RCVR). Mobile device 190 and watch device 312 can also include sensors that detect orientation and motion, for example, an accelerometer, a gyroscope, a compass, a magnetometer. Further, mobile device 190, watch device 312, and a camera sensor, for example a camera sensor provided by camera 245 can provide biometric measurements of a user and biometric user authentication such as face recognition or fingerprint recognition.

Furthermore, watch 312, clothing 314, enclosed structure 316, wearable sensor 318, object transport structure 320, object 322, and luggage 324 can include UWB which uses radio technology to transmit a signal to receiver and data aggregator 195. UWB uses radio waves for high-bandwidth communication over a large portion of the radio spectrum (>500 MHz) to communicate information such as position location. A UWB enabled device can utilize low power to maintain high-bandwidth connections.

Watch device 312, clothing 314, enclosed structure 316, wearable sensor 318, object transport structure 320, object 322, and luggage 324 and/or components of the sensor equipped objects are capable of communicating with each other in some embodiments, and directly with network 170 in other embodiments.

FIG. 3B illustrates an example of geolocation sensors and/or transmitters located within a monitored location. Monitored location 350, is an example monitored location that is illustrated using four positional anchors, first position anchor 352, second position anchor 354, third position anchor 356, and fourth position anchor 358. Collectively, first position anchor 352, second position anchor 354, third position anchor 356, and fourth position anchor 358 provide geofence 362. Optionally, at least one anchor, an indoor indicator, and/or an outdoor indicator can be used to delineate a monitored location from a non-monitored location. Additionally, coordinate 360 provides location coordinates that represent a vertical position, and at least one horizontal position.

In operation, first position anchor 352, second position anchor 354, third position anchor 356, and fourth position anchor 358 form geofence 362, which establishes/represents the boundaries of monitored location 350. A sensing technique, such as GPS or RFID, is utilized to generate a virtual barrier that delineates monitored location 350 from a non-monitored location.

According to one embodiment, processor 105 receives data, in the form of coordinates 360 that identify the geographic location. In one embodiment, coordinate 360 is provided as a precise three axis (x, y, z) data group. In response to receiving data when a sensing device intersects and/or crosses the virtual barrier of geofence 362, one or more operations associated with MDU 242 operating on mobile device 190, are triggered. Crossing the virtual barrier of geofence 362 may also trigger an operation of watch device 312, enclosed structure 316, wearable sensor 318, and/or components of the sensor equipped objects.

In one embodiment, coordinates are received at receiver and data aggregator 195 and forwarded to processor 105, in a specified sequence to establish geofence 362. A sensing device detects translational activity that corresponds to a change in at least one value of the coordinates 360 of the device/object being tracked/monitored within the geographic location. In response to receiving specified coordinate values and/or specified changes in the coordinates, MDU 142 (or 242) identifies first position anchor 352. Coordinates for identifying additional anchors that define geofence 362 are subsequently received.

Geofence 362 illustrated in FIG. 3B is for example only. It is understood that geofence 362 is operable using as few as one position anchor. The one position anchor can be used to form a virtual barrier line or a radially defined virtual barrier for delineating the monitored location from a non-monitored location. Additionally, monitored location 350 can be identified by a specified user entering and/or exiting a building, structure, or an outdoor environment. The location is identified as a monitored location when one or more predetermined coordinate values for the location corresponds to at least one detected coordinate value that defines monitored location 350. The preselected coordinate value can be a value stored within storage 220 of mobile device 190. In response to the specified user, utilizing mobile device 190 and intersecting the coordinate value, processor 205 initiates continuous monitoring of the specified user's movements and gestures. Accordingly, receiver and data aggregator 195 detects and transmits coordinate values of the specified user's movements/gestures to DPS 100 via network 170 as the specified sensing device moves about monitored location 350.

In still another embodiment, multiple different locations can be designated as a monitored location. Triggering of monitoring, at any of the multiple different locations, can be based on the identification of data received and/or detected, such as coordinate data, that corresponds to the identified location. However, in still another embodiment a new location can be established that has not been previously identified as a monitored location. In this embodiment, a user can perform a specified sequence of gestures and/or actions, as captured by a sensing device such as mobile device 190. The gestures and/or actions, performed in a same location indicate the user is performing a certain activity and thereby triggers a geofenced area to form around the area of activity.

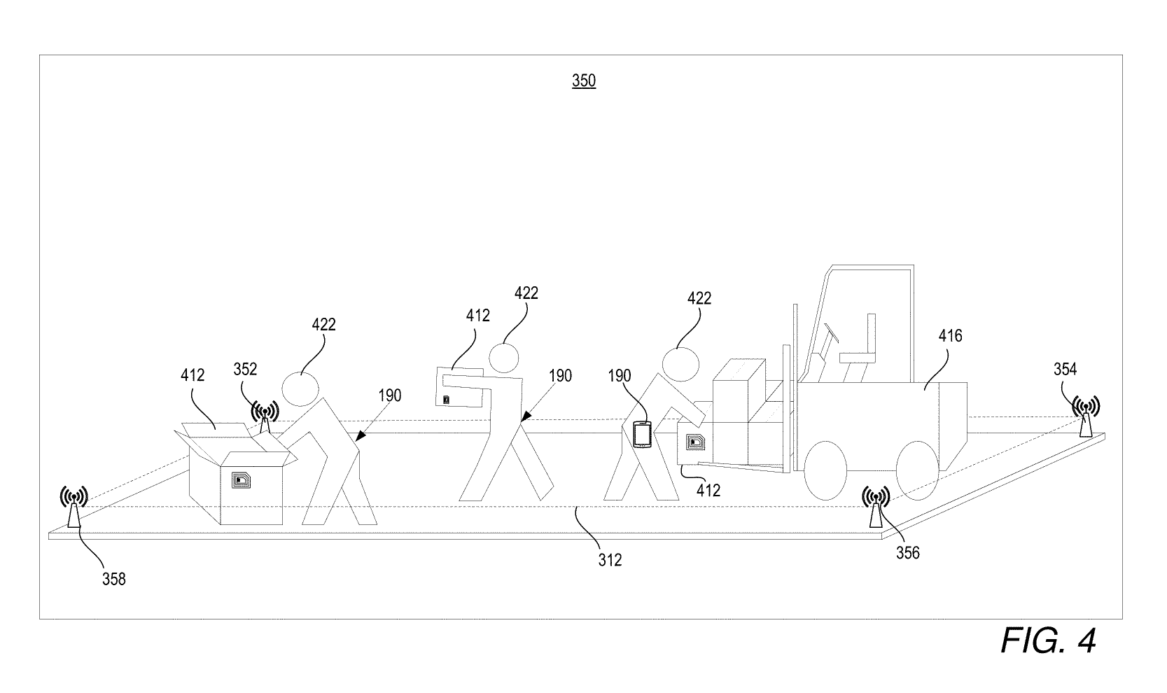

FIG. 4 illustrates examples of translation activity taking place in a monitored location, according to one or more embodiments. For purposes of this description, monitored location 350 includes first position anchor 352, second position anchor 354, third position anchor 356, and fourth position anchor 358 which form geofence 362. Additionally, monitored location 350 includes sensor equipped object 412, mobile device 190, non-sensor equipped object 416, and user 422.

In one example, user 422 is actively transporting/carrying objects in monitored location 350. User 422 is carrying mobile device 190. User 422 transports sensor equipped object 412 from a first location to a second location. As user 422 moves about monitored location 350, location data associated with those movements are tracked/monitored by sensors within mobile device 190. Location coordinates are received and aggregated by receiver and data aggregator 195. Receiver and data aggregator 195 then transmits the location data to DPS 100 via network 170. The transmitted data is received at processor 105, executing MDU 142. Processor 105 evaluates and processes the received data, as described herein. The data collected by mobile device 190 includes at least one location coordinate that is, at least in part, indicative of a geographic location of mobile device 190. In one embodiment, the location coordinate corresponds to at least one specific movement of mobile device 190 within the geographic location. In another embodiment, the location coordinate corresponds to continuous movement of the sensor equipped object. In one embodiment, multiple user devices are utilized to collect data. The data collected from the multiple user devices provides a group of coordinates that correspond to a more concise position and movements of user 422, user device 414, and/or sensor equipped object 412. For example, when user 422 is wearing: (1) wearable sensor 318 on his/her hand, (2) mobile device 190 on his/her hip, and (3) a second wearable sensor on his/her ankle, each sensor provides location coordinates that correspond to that body part's movement. In which case, processor 105 is able to more specifically identify particular movements of user 422. Additionally, secondary data, which includes other specifics associated with the identity of the user, objects, atmospheric conditions, data aggregated from sensors in the surrounding area etc. can be collected and analyzed by MDU 142 to enhance understanding of a gesture, and/or operation being performed. Mobile device 190 can also be, for example, a device selected from among sensor network 300. According to one aspect, a sequence of coordinates collected from various sensors within sensor network 300 form a multi-dimensional coordinate grid that identifies, in real-time, the geographic location and the specific movement of any one of the devices and/or objects within monitored location 350.

In response to receiving the data, processor 105 (or 205) determines whether the geographic location of mobile device 190 is a location in which activities are monitored. In response to the geographic location being an identified, monitored location, processor 105 determines which specific movements, associated with user 422, are presented by the at least one coordinate. In one embodiment, the data, received at processor 105, comprises a sequence of coordinates taken as the user device moves from one position to another within the geographic location. Processor 105 determines a frequency of movements from the sequence of coordinates. In response to determining which movements are presented by the sequence of coordinates and identifying a frequency of the movements, processor 105 autonomously executes a second operation, based, in part, on the identified specific operation that is occurring in the geographic location and in part on a frequency of occurrence of the identified specific operation.

In one embodiment, processor 105 executes MDU 142 which identifies, from a location-based operation mapping (LBOM) database, a performance of a specific operation that correlates to the at least one coordinate. According to one embodiment, the LBOM is a database, for example database 152 (of FIG. 1), of a cloud-based processing entity that provides artificial intelligence (AI) learning based on received real-time coordinates and archived coordinates that correspond to known patterns of specific movements. When processor 105 receives the data, processor 105 provides a sequence of coordinates to the cloud-based processing entity. The cloud-based processing entity of the LBOM database determines a statistical model of movements associated with user 422. Further, processor 105, executing MDU 142, generates a predictive model using predictive analytics on data in the LBOM database to correlate a statistical frequency of coordinates with the known patterns of specific movements. The predictive analytics are used to forecast specific movements and an effect of the specific movements. For example, the predictive analytics can be utilized to form a checklist of known steps for completing a process. When a step is missed, processor 105 generates a communicative message identifying the missed step. In another example, predictive analytics can be utilized to identify the effects of a continuous ergonomically correct and/or incorrect motion as determined by the predictive model.

In response to processor 105 (or 205) receiving the at least one specific movement in real-time, processor 105 (or 205) identifies a pattern associated with a group of specific movements. For example, as user 422 pivots, turning in an opposite direction of the first position, and walks sensor equipped object 412 to the second location, a sensing device detects the position change and transmits the new coordinate values to receiver aggregator 195. Processor 105 (or 205) archives the specific movement of user 422 from the first position to each subsequent position, and a pattern of the specific movements in the LBOM database (such as database 152). Additionally, processor 105 may archive the speed of the activity and the time elapsed for completing the task. Further, the geographic location of sensor equipped object 412 is collected when the sensor of sensor equipped object 412 is in close proximity to a receiving sensor associated with mobile device 190 and/or another sensing device within monitored location 350. The data provided by the sensor on sensor equipped object 412 can be collected by mobile device 190 or a nearby receiver/transceiver. LBOM database is updated with data received from mobile device 190 and other sensing devices within monitored location 350.

Further, in another embodiment, processor 105 aggregates the specific movement received in real-time with the specific movement that is archived, to form a known pattern of specific movements. MDU 142 autonomously executes an expected action in response to identifying the known pattern of specific movements. The expected action, may be, for example, generating a scan of sensor equipped object 412. Processor 105 correlates, within LBOM database 152, the specific movement occurring within the geographic location with a resulting operation that can affect an object within monitored location 350. Processor 105 performs a second operation, based, in part, on an identified specific operation that is being performed in monitored location 350. The second operation, for example, may include, executing a subsequent scan of another object, generating a document and/or message, and signaling the end and/or beginning of an event.

In still another embodiment, the geographic location is defined by geofence 362, and processor 105 identifies the presence of geofence 362 based on receipt of the data. Processor 105 triggers at least one of mobile device 190 and another device located within a known geofenced location to collect additional event data. Further, processor 105 performs the second operation only when the coordinate correlates to a known geofenced location that is being monitored.

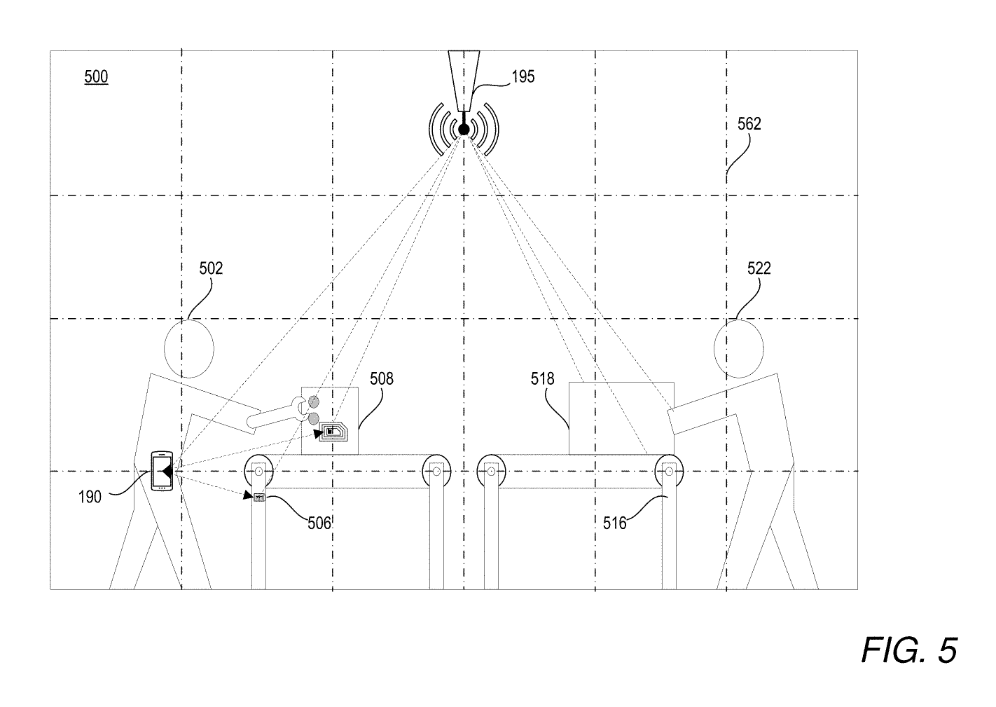

Now turning to FIG. 5, which illustrates an example sensing device for detecting the transmission of electrical signals from sensor equipped devices at a geographic location. Geographic location 500 includes receiver and data aggregator 195, user 502 and 522, mobile device 190, sensor equipped conveyor 506, conveyor 516, sensor equipped object 508, and non-sensor equipped object 518. Geolocation 500 is defined by geofence 562.

In one example, mobile device 190 is worn and/or carried by user 502. Mobile device 190 communicates with sensor equipped conveyor 506, sensor equipped object 508, and receiver and data aggregator 195 via previously mentioned sensing technologies. Receiver and data aggregator 195 may utilize an antenna to collect data in the form of electrical signals. Mobile device 190 comprises, at least in part, at least one component that (i) uniquely identifies the specific movement of the user device, (ii) detects geographic location coordinates, and (iii) identifies an object (508) in geographic location 500, the at least one component being a detection device. For example, the detection device can be selected from among the following sensor technologies: a near field communication device, a cellular device, a real-time geographic location device, and a radio-frequency identification device, wherein a sequence of coordinates form a multi-dimensional coordinate grid that identifies, in real-time, the geographic location and the specific movement of the user device.

The data is provided to DPS 100. Processor 105 executes MDU 142 to activate a learning mode that identifies movements sensed by mobile device 190. In response to activation of the learning mode, processor 105 identifies a pattern of specific movements that are tracked by mobile device 190 at geographic location 500. The pattern of specific movements tracked by mobile device 190 correspond to a sequence of coordinates received by user 502 when user 502 changes position and/or moves to different locations. In one embodiment, mobile device 190 can be set to a specified tolerance level to track fine movement changes and coarse movement changes of user 502. MDU 142 selectively correlates the pattern of specific movements to at least one pre-identified operation that corresponds to an activity or a task that is performed and collected by receiver and data aggregator 195 within geographic location 500. In response to correlating the pattern of specific movements to the at least one pre-identified operation, MDU 142 detects initiation of a specific task and a time of duration of the specific task. MDU 142 determines a frequency of the pattern of specific movements.

As a simple example, MDU 142 identifies a number of bolt turns for sensor equipped object 508, and moves the conveyor belt according to when the task is complete, or expected to be completed. In response to sensor equipped conveyor 506 detecting the absence of mobile device 190, and thereby the absence of user 502, sensor equipped conveyor halts motion of the conveyor belt. In response to determining that at least one specific movement, from among the pattern of specific movements, is absent, MDU 142 generates an informative communication. Therefore, in the event that the bolts on sensor equipped object 508 did not receive enough turns, MDU 142 generates an informative communication that identifies user 502, object 508, how many turns were completed (or are missing), and the current location of the object.

In one embodiment, user 502 is creating gestures and/or moving within geographic location 500. Mobile device 190 tracks movements of user 502 by identifying the sequence of coordinates associated with the movements. MDU 142 receives at least one specific movement in real-time. MDU 142 identifies a pattern associated with a group of specific movements. Processor 105 archives the specific movement and a pattern of specific movements in the LBOM database, for example database 152. As real-time data is received by receiver and data aggregator 195, the LBOM database is updated with data received that corresponds to the movement of mobile device 190 within geographic location 500. Accordingly, MDU 142 aggregates the specific movement received in real-time with the specific movement that is archived. From the aggregation of the specific movement received in real-time with the specific movement that is archived, MDU 142 forms a known pattern of specific movements.

In still another example, receiver and data aggregator 195 is communicatively coupled to a sensor that utilizes motion sensing to approximate location coordinates Receiver and aggregator 195 identifies the coordinates and/or sequence of coordinates from a known coordinate grid established to identify coordinates of geographic location 500. In this embodiment, user 522 is not wearing a sensor device, nor is a sensor device connected to object 518 and conveyor 516. Still, receiver and data aggregator 195 monitors the movements of user 522 within the coordinate grid established by a geofence 562, and retrieves the corresponding coordinates. MDU 142 identifies a pattern associated with a group of specific movements. Processor 105 archives the specific movement and a pattern of specific movements in LBOM database 152. As real-time data is received by receiver and data aggregator 195, LBOM database 152 is updated with data received from data aggregator 195 within geographic location 500. Accordingly, MDU 142 aggregates the specific movement received in real-time with the specific movement that is archived. From the aggregation of the specific movement received in real-time with the specific movement that is archived, MDU 142 forms a known pattern of specific movements.

Further, in one embodiment, LBOM database 152 is a database of a cloud-based processing entity. Processor 105 provides artificial intelligence (AI) learning based on received real-time coordinates and archived coordinates that correspond to known patterns of specific movements. Further, processor 105 provides a sequence of coordinates to the cloud-based processing entity. The cloud-based processing entity of LBOM database 152: (i) determines a statistical model of movements, and (ii) generates a predictive model using predictive analytics on data in LBOM database 152. The predictive analytics correlate a statistical frequency of coordinates with the known patterns of specific movements, to forecast specific movements and an effect of the specific movements.

In still another embodiment, executing on processor 105, MDU 142, autonomously executes an expected action in response to identifying the known pattern of specific movements. For example, in response to identifying the known pattern of specific movements, user 502 executes a known number of turns on sensor equipped object 508 (or a non-sensor equipped object), MDU 142 signals the sensor equipped conveyor to deliver another object. Therein, MDU 142 identifies, within LBOM database 152, the specific movement that is occurring within geographic location 500 with a resulting operation. The resulting operation can affect one or more of an object within geographic location 500, user 502, mobile device 190, and/or an operational system within geographic location 500.

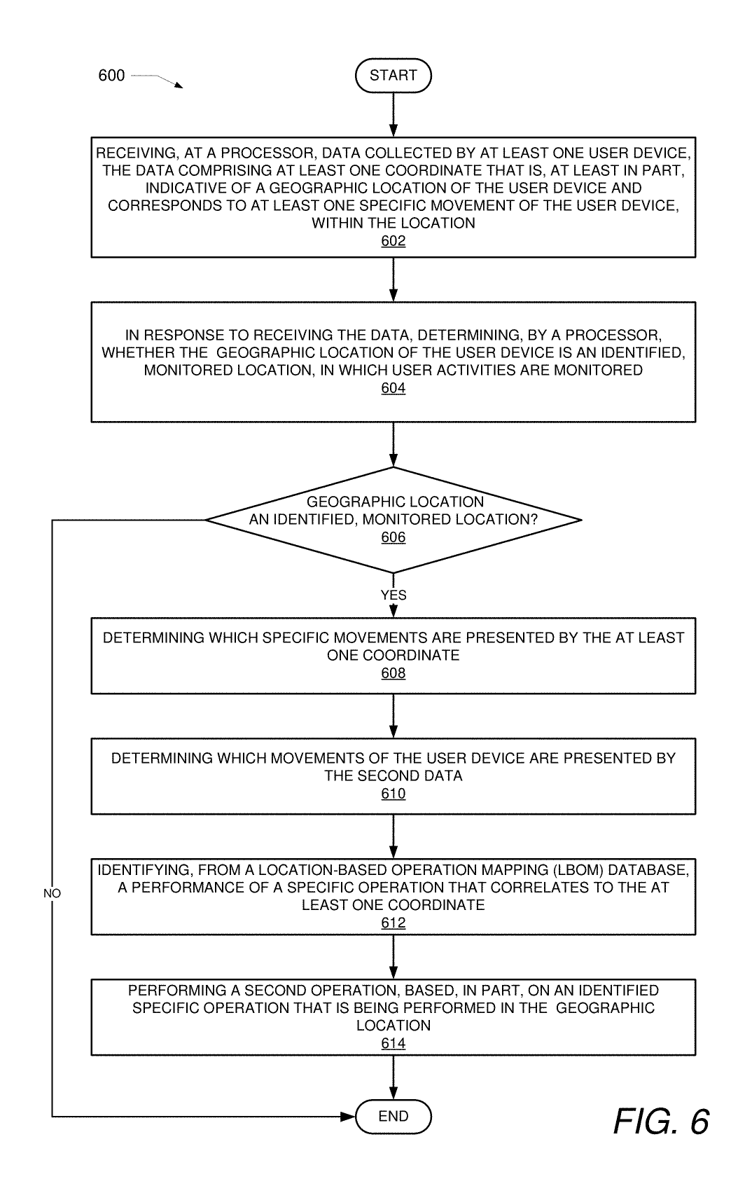

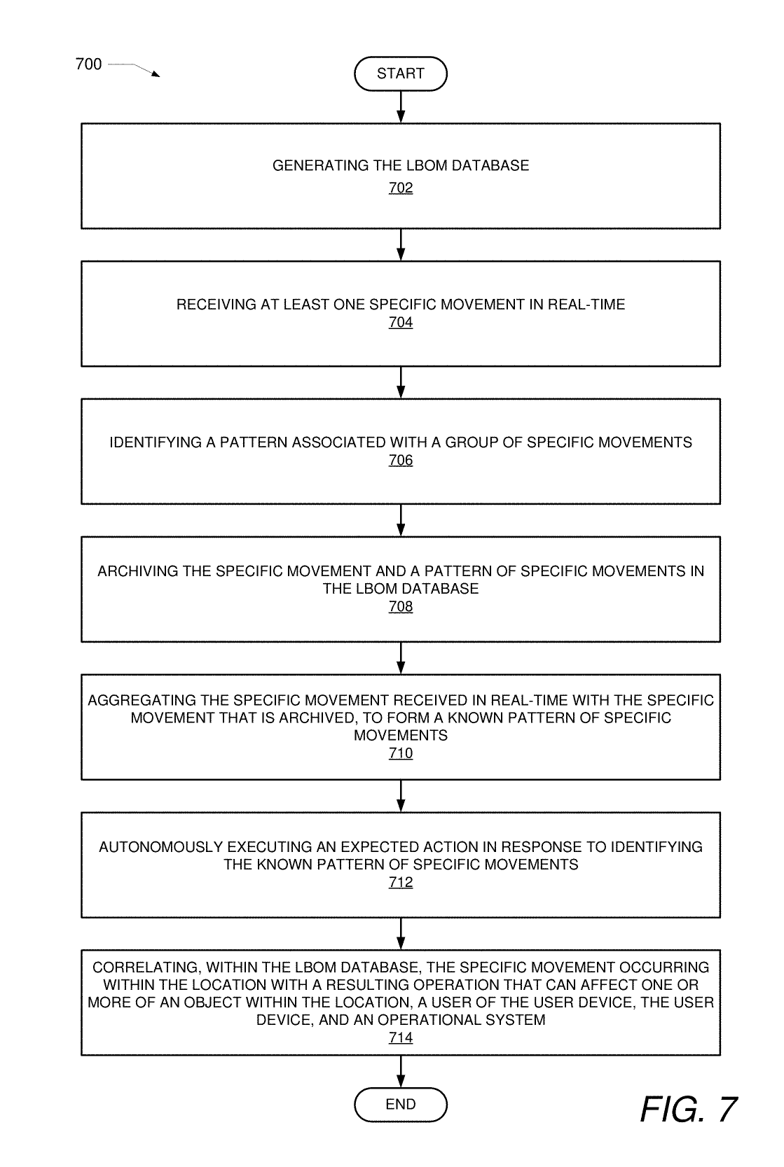

Referring now to FIG. 6 and FIG. 7. FIG. 6 provides a method for determining when to perform a second operation, based, in part, on an identified specific operation that is being performed in the an identified, monitored location, in accordance with one or more embodiments of the present disclosure. FIG. 7 provides a method for correlating specific movements being performed in an identified, monitored location, with a resulting operation that can affect an object and/or a user of a user device. Aspects of the methods are described with reference to the components of FIGS. 1-5. Several of the processes of the method provided in FIG. 6 and FIG. 7 can be implemented by a processor (e.g., processor 105) executing software code of MDU 142. In the following method processes described in FIG. 6 and FIG. 7, processor 105 executes MDU 142 to perform the steps described herein.

Method 600 commences at the start block, then proceeds to block 602. At block 602 of the method, processor 105 receives data collected by at least one user device (190), the data comprising at least one coordinate 310 that is, at least in part, indicative of a geographic location of the user device and corresponds to at least one specific movement of the user device, within a geographic location. At block 604, in response to receiving the data by processor 105, processor 105 determines whether the geographic location of user device 504 is an identified, monitored location, in which user activities are monitored. Processor 105 makes a decision at block 606 that determines whether the geographic location is an identified, monitored location. In response to the geographic location not being an identified, monitored location, the method ends. In response to the geographic location being an identified, monitored location, processor 105 determines which specific movements are presented by the at least one coordinate, at block 608. At block 610 of the method, processor 105 determines which specific movements are presented by the second data. At block 612, processor 105 identifies, from a location-based the LBOM database, a performance of a specific operation that correlates to the at least one coordinate. At block 614, processor 105 performs a second operation, based, in part, on an identified specific operation that is being performed in the geographic location. The process concludes at the end block.

Method 700 commences at the start block, then proceeds to block 702. At block 702 the processor 105 generates the LBOM database (152). At block 704, processor 105 receives at least one specific movement in real-time. Processor 105 identifies a pattern associated with a group of specific movements, at block 706. At block 708, processor 105 archives the specific movement and a pattern of specific movements in the LBOM database (152). Processor 105 aggregates the specific movement received in real-time with the specific movements that is archived, at block 710, to form a known pattern of specific movements. At block 712, processor 105 autonomously executes an expected action in response to identifying the known pattern of specific movements. At block 714, processor 105, correlates within the LBOM database (152), the specific movement occurring within the geographic location with a resulting operation that can affect one or more of an object within the geographic location, a user of the user device, the user device, and an operational system. The process concludes at the end block.

In the above-described flow charts, one or more of the method processes may be embodied in a computer readable device containing computer readable code such that a series of steps are performed when the computer readable code is executed on a computing device. In some implementations, certain steps of the methods are combined, performed simultaneously or in a different order, or perhaps omitted, without deviating from the scope of the disclosure. Thus, while the method steps are described and illustrated in a particular sequence, use of a specific sequence of steps is not meant to imply any limitations on the disclosure. Changes may be made with regards to the sequence of steps without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object oriented programming language, without limitation. These computer program instructions may be provided to a processor of a general purpose computer, special purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain, or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals; but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A data processing device comprising:
a processor that:
receives data collected by at least one user device, the data comprising at least one coordinate that is, at least in part, indicative of a geographic location of the user device and corresponds to at least one specific movement of the user device within the geographic location;
a movement detection utility executing on the processor and which:
in response to receiving the data, determines whether the geographic location of the user device is an identified, monitored location, in which activities are monitored; and
in response to the geographic location being an identified, monitored location:
determines which specific movements are presented by the at least one coordinate;
identifies, from a database, a performance of a specific operation that correlates to the at least one coordinate; and
performs a second operation, based, in part, on an identified specific operation that is being performed in the geographic location.

2. The data processing device of claim 1, wherein the geographic location is defined by a geofence, and the processor:
identifies a presence of the geofence based on receipt of the data;
triggers at least one of the user device and another device located within a known geofenced location to collect additional event data; and
performs the second operation only when the coordinate correlates to a known geofenced location that is being monitored.

3. The data processing device of claim 1, wherein:
the data comprises a sequence of coordinates taken as the user device moves from one position to another within the geographic location; and
the processor:
receives the sequence of coordinates;
determines a frequency of movements from the sequence of coordinates; and
in response to determining which movements are presented by the sequence of coordinates and identifying a frequency of the movements, autonomously executes the second operation, based, in part, on the identified specific operation that is occurring in the geographic location and a frequency of occurrence of that operation.

4. The data processing device of claim 1, wherein the processor:
in response to activation of a learning mode, identifies a pattern of specific movements tracked by the user device within the geographic location that correspond to a sequence of coordinates received; and
selectively correlates the pattern of specific movements to at least one pre-identified operation that corresponds to an activity or a task that is performed within the geographic location.

5. The data processing device of claim 4, wherein, in response to correlating the pattern of specific movements to the at least one pre-identified operation, the processor:
detects initiation of a specific task and a time of duration of the specific task;
determines a frequency of the pattern of specific movements; and
in response to determining that at least one specific movement, from among the pattern of specific movements, is absent, generates an informative communication.

6. The data processing device of claim 1, wherein the processor:
receives the at least one specific movement in real-time;
identifies a pattern associated with a group of specific movements;
archives the specific movement and a pattern of specific movements in the database, wherein the database is a location-based operation mapping (LBOM) database and is updated with data received from the user device within the geographic location that is monitored;
aggregates the specific movement received in real-time with the specific movement that is archived, to form a known pattern of specific movements;
autonomously executes an expected action in response to identifying the known pattern of specific movements; and
correlates, within the LBOM database, the specific movement occurring within the geographic location with a resulting operation that can affect one or more of an object within the geographic location, a user of the user device, the user device, and an operational system.

7. The data processing device of claim 1, wherein:
the database is a cloud-based processing entity that provides artificial intelligence (AI) learning based on received real-time coordinates and archived coordinates that correspond to known patterns of specific movements; and
the processor provides a sequence of coordinates to the cloud-based processing entity; and
the cloud-based processing entity of the database:
determines a statistical model of movements; and
generates a predictive model using predictive analytics on data in the database to correlate a statistical frequency of coordinates with the known patterns of specific movements, to forecast specific movements and an effect of the specific movements.

8. The data processing device of claim 1 wherein the user device comprises, at least in part, at least one component that (i) uniquely identifies the specific movement of the user device, (ii) detects geographic location coordinates, and (iii) identifies an object in the geographic location, the at least one component being a detection device.

9. The data processing device of claim 1 wherein the user device is at least one of a near field communication device, a cellular device, a real-time geographic location device, and a radio-frequency identification device, wherein a sequence of coordinates form a multi-dimensional coordinate grid that identifies, in real-time, the geographic location and the specific movement of the user device.

10. A method comprising:
receiving, at a processor, data collected by at least one user device, the data comprising at least one coordinate that is, at least in part, indicative of a geographic location of the user device and corresponds to at least one specific movement of the user device, within the geographic location;
in response to receiving the data, determining, by the processor, whether the geographic location of the user device is an identified, monitored location, in which user activities are monitored; and
in response to the geographic location being an identified, monitored location:
determining which specific movements are presented by the at least one coordinate;
identifying, from a database, a performance of a specific operation that correlates to the at least one coordinate; and
performing a second operation, based, in part, on an identified specific operation that is being performed in the geographic location.

11. The method of claim 10, wherein the geographic location is defined by a geofence, further comprises:
identifying a presence of the geofence based on receipt of the data;
triggering at least one of the user device and another device located within a known geofenced location to collect additional event data; and
performing the second operation only when the coordinate correlates to a known geofenced location that is being monitored.

12. The method of claim 10, further comprises:
receiving a sequence of coordinates, wherein the data comprises a sequence of coordinates taken as the user device moves from one position to another within the geographic location;
determining a frequency of movements from the sequence of coordinates; and
in response to determining which movements are presented by the sequence of coordinates and identifying a frequency of the movements, autonomously executes the second operation, based, in part, on the identified specific operation that is occurring in the geographic location and a frequency of occurrence of that operation.

13. The method of claim 10, further comprises:
in response to activating a learning mode, identifies a pattern of specific movements tracked by the user device within the geographic location that correspond to a sequence of coordinates received;
selectively correlating the pattern of specific movements to at least one pre-identified operation that corresponds to an activity or a task that is performed within the geographic location;
in response to correlating the pattern of specific movements to the at least one pre-identified operation, detecting initiation of a specific task and a time of duration of the specific task;
determining a frequency of the pattern of specific movements; and
in response to determining that at least one specific movement, from among the pattern of specific movements, is absent, generating an informative communication.

14. The method of claim 10, further comprising:
receiving the at least one specific movement in real-time;
identifying a pattern associated with a group of specific movements;
archiving the specific movement and a pattern of specific movements in the database, wherein the database is a location-based operation mapping (LBOM) database and is updated with data received from the user device within the geographic location that is monitored;
aggregating the specific movement received in real-time with the specific movement that is archived, to form a known pattern of specific movements;
autonomously executing an expected action in response to identifying the known pattern of specific movements; and
correlating, within the LBOM database, the specific movement occurring within the geographic location with a resulting operation that can affect one or more of an object within the geographic location, a user of the user device, the user device, and an operational system.

15. The method of claim 10, wherein:
the database is cloud-based processing entity that provides artificial intelligence (AI) learning based on received real-time coordinates and archived coordinates that correspond to known patterns of specific movements; and
the processor provides a sequence of coordinates to the cloud-based processing entity; and
the cloud-based processing entity of the database comprises:
determining a statistical model of movements; and
generating a predictive model using predictive analytics on data in the database to correlate a statistical frequency of coordinates with the known patterns of specific movements, to forecast specific movements and an effect of the specific movements.

16. The method of claim 10, further wherein:
the user device comprises, at least in part, at least one component that (i) uniquely identifies the specific movement of the user device, (ii) detects geographic location coordinates, and (iii) identifies an object in the geographic location, the at least one component being a detection device; and
the user device is at least one of a near field communication device, a cellular device, a real-time geographic location device, and a radio-frequency identification device, wherein a sequence of coordinates form a multi-dimensional coordinate grid that identifies, in real-time, the geographic location and the specific movement of the user device.

17. A computer program product comprising:
a computer readable storage device; and
program code on the computer readable storage device that when executed within a processor associated with a device, the program code enables the device to provide a functionality of:
receiving, at a processor, data collected by at least one user device, the data comprising at least one coordinate that is, at least in part, indicative of a geographic location of the user device and corresponds to at least one specific movement of the user device, within the geographic location;
in response to receiving the data, determining, by a processor, whether the geographic location of the user device is an identified, monitored location, in which user activities are monitored; and
in response to the geographic location being an identified, monitored location:
determining which specific movements are presented by the at least one coordinate;
identifying, from a database, a performance of a specific operation that correlates to the at least one coordinate; and
performing a second operation, based, in part, on an identified specific operation that is being performed in the geographic location.

18. The computer program product of claim 17, further comprises:
identifying a presence of a geofence based on receipt of the data, wherein the geographic location is defined by the geofence;
triggering at least one of the user device and another device located within a known geofenced location to collect additional event data;
performing the second operation only when the coordinate correlates to a known geofenced location that is being monitored;
receiving a sequence of coordinates, wherein the data comprises a sequence of coordinates taken as the user device moves from one position to another within the geographic location;
determining a frequency of movements from the sequence of coordinates;
in response to determining which movements are presented by the sequence of coordinates and identifying a frequency of the movements, autonomously executes the second operation, based, in part, on the identified specific operation that is occurring in the geographic location and a frequency of occurrence of that operation;
in response to activating a learning mode, identifies a pattern of specific movements tracked by the user device within the geographic location that correspond to a sequence of coordinates received;
selectively correlating the pattern of specific movements to at least one pre-identified operation that corresponds to an activity or a task that is performed within the geographic location;
in response to correlating the pattern of specific movements to the at least one pre-identified operation, detecting initiation of a specific task and a time of duration of the specific task;
determining a frequency of the pattern of specific movements; and
in response to determining that at least one specific movement, from among the pattern of specific movements, is absent, generating an informative communication.

19. The computer program product of claim 17, wherein:
the database is a cloud-based processing entity that provides artificial intelligence (AI) learning based on received real-time coordinates and archived coordinates that correspond to known patterns of specific movements; and
the processor provides a sequence of coordinates to the cloud-based processing entity; and
the program code further enables the cloud-based processing entity of the database to provide a functionality of:
determining a statistical model of movements; and
generating a predictive model using predictive analytics on data in the database to correlate a statistical frequency of coordinates with the known patterns of specific movements, to forecast specific movements and an effect of the specific movements.

20. The computer program product of claim 17, wherein:
the user device comprises, at least in part, at least one component that (i) uniquely identifies the specific movement of the user device, (ii) detects geographic location coordinates, and (iii) identifies an object in the geographic location, the at least one component being a detection device; and
the user device is at least one of a near field communication device, a cellular device, a real-time geographic location device, and a radio-frequency identification device, wherein a sequence of coordinates form a multi-dimensional coordinate grid that identifies, in real-time, the geographic location and the specific movement of the user device.
